(19) United States
(12) Patent Application Publication
(10) Pub. No.: US 2008/0312823 A1
(43) Pub. Date: Dec. 18, 2008

(54) Providing the grid and magnetic azimuths on the electronic maps, and embedding grid magnetic angle, magnetic declination and inclination into the electronic map databases

(76) Inventor: Jiantao Huang, Milpitas, CA (US)

Correspondence Address: Jiantao Huang, 540 Alder Drive, Milpitas, CA, 95035, US

(21) Appl. No.: 11/811,770

(22) Filed: Jun. 13, 2007

(51) Int. Cl. G01C 21/32

(52) U.S. Cl. 701/208

(57) ABSTRACT

An electronic Interactive Navigation Map was built to provide the Magnetic Azimuths θ_{M} of desired moving directions relative to the Magnetic North. The system presents the most useful information for navigation. The system connects a series of waypoints by straight-line segments, and provides one pair of (θ_{M}, d) values per segment. Existing electronic maps are designed for road navigation, but lack the key azimuth information for navigation in no-road environment. To compute the θ_{M}, the Interactive Navigation Map needs the Grid Magnetic Angle that can be obtained by various methods including: 1. Asking the user to interactively input the information. 2. Sending an instant database query to National Geophysical Data Center or other resources over the Internet. 3. Embedding the Grid Magnetic Angle, Magnetic Declination and Inclination into the electronic map database.

### CROSS-REFERENCE TO RELATED APPLICATIONS

This is the first filing of this “Interactive Navigation Map” application. There is no related pending or granted application filed previously.

### STATEMENT REGARDING FEDERALLY SPONSORED RESEARCH OR DEVELOPMENT

The inventor grants the rights to inventions made under federally sponsored research and development.

### BACKGROUND OF THE INVENTION

Previous electronic maps focus on providing driving instruction in a world connected by roads. Therefore road and distance information are provided. However, when hiking in the field, sailing or aviating, the road information is not applicable and the distance information cannot uniquely determine the destination. For instance, the previous “Kloba Filter” (http://www.klobad.com/maps/) accepts interactive input of a series of waypoints, connects those points into straight-line segments, and adds up the distance of all segments. By assuming the users select the path along the streets, the Kloba Filter works fine in urban environment. However, if the map is a golf course or a rural or mountainous area, and the terrain obstructs the view of destination, the current location (A) and the destination location (B) can still be entered on the electronic interactive map. Then the Kloba Filter draws the straight-line segment connecting (A) and (B) and provides the distance only, which is not sufficient to guide the navigation because there is no street to follow and the destination is not in the view, as in the case of FIG. 2.

Related literatures on navigation include the “U.S. Army Map Reading and Land Navigation Handbook” by the Department of the Army, “The Annapolis Book of Seamanship” by Simon & Schuster, etc. Those literatures, explaining navigation technologies based on compass and paper maps, are knowledge before the emergence of electronic maps. This invention is the first application of the inventor's navigation experience to the electronic interactive map.

The following are terminologies used by this application (see FIG. 1 for their graphic depictions):

True North (TN) is the direction of a meridian of longitude that converges on the North Pole. Note: This is just a technical method of saying that True North describes a direct line to the North Pole and the Earth's spin axis.

Grid North (GN) is the direction of a grid line that is parallel to the central meridian on a map. Note: Grid North does not match True North because a map is a flat representation of a curved surface.

Magnetic North (MN) is the direction indicated by a magnetic compass. Note: Magnetic North varies with geographic locations.

Grid Magnetic Angle θ_{GM} (angle (2) in FIG. 1) is the horizontal angle between Grid North and Magnetic North. This Angle is positive when the Magnetic North is east of Grid North, and negative when it is west of Grid North. It normally ranges from zero to a few dozens degrees. It is this angle which needs to be applied when converting between magnetic and grid bearings.

Magnetic Declination (also called magnetic variation) at any point on the Earth is the horizontal angle between the True North and the Magnetic North (angle (4) in FIG. 1). Magnetic declination varies both from place to place, and with the passage of time. This difference reflects the tilt of the earth's magnetic field in respect to its axis of rotation. More information can be found at National Geophysical Data Center (NGDC): http://www.ngdc.noaa.gov/seg/geomag/declination.shtml . Magnetic declination of any specific area can be found by entering the zip code or latitude and longitude at this link: http://www.ngdc.noaa.gov/seg/geomag/jsp/struts/calcDeclination

Magnetic Inclination (also called the dip angle) is the vertical angle that the geomagnetic field is tilted with respect to the surface of the earth. Magnetic inclination varies from 90° (perpendicular to the surface) at the magnetic poles to 0° (parallel to the surface) at the magnetic equator. The magnitude of the Magnetic Inclination with respect to the ground provides a rough indication of latitude.

### BRIEF SUMMARY OF THE INVENTION

For the ease of description, this application defines two azimuths as marked in FIG. 1: “Grid Azimuth θ_{G}” is the horizontal angle (3) between Grid North and the travel direction—vector AB. “Magnetic Azimuth θ_{M}” is the horizontal angle (1) between Magnetic North and the vector AB. The application also defines a “Leg” as a straight-line segment connecting two contiguous waypoints selected by the user along the travel path. For instance, vector AB is a leg (L).

This invention calculates the Grid Azimuth and displays the Magnetic Azimuth on the electronic map. The previous Kloba Filter could be a lot more useful, should it output the azimuth along with the distance information for each leg of user-selected path in the electronic interactive map. The azimuth and distance uniquely determine the destination on the earth's surface. Suppose the user clicks on points (A) and (B) on the electronic map, the Grid Azimuth can be calculated from the coordinates of (A) and (B) directly. The Magnetic Azimuth is obtained by subtracting the Grid Magnetic Angle from the Grid Azimuth.

### BRIEF DESCRIPTION OF THE DRAWINGS

FIG. 1 shows the True North (TN), Grid North (GN), Magnetic North (MN) and the azimuth definitions: Magnetic Azimuth (1); Grid Magnetic Angle (2); Grid Azimuth (3); Magnetic Declination (4). The destination (B) is normally at a remote distance (d), for instance, 200 meters. By the Compass convention (II), the Grid North is marked as 0°, and it goes clockwise with degree increasing to 360° to complete a full circle. In this FIG, Grid Magnetic Angle (2) is positive (East of Grid North). This invention uses (θ_{M}, d) to uniquely determine the destination, where θ_{M}, the Magnetic Azimuth (1), is readily available from a compass (10) reading.

FIG. 2 demonstrates the previous Kloba Filter, which works fine when the trip is along the roads. Here the navigator has to move from starting point (A) to destination point (B) in a no-road setting. In this FIG, the path contains one leg (L) crossing the hill (20). The Kloba Filter outputs the distance of 0.42 miles (675.8 meters) but no azimuth information. Due to the lack of road to follow and the obstruction of the destination by the hill, the navigator has difficulty to decide the moving direction.

FIG. 3 demonstrates how this invention improves the previous technology by adding the azimuth information. Here the magnetic azimuth is the horizontal angle (1) between the magnetic north (MN) and the travel direction (L). The Interactive Navigation Map outputs the magnetic azimuth and the distance in this format (34.5°, 0.42 miles). The azimuth between the desired travel direction and the magnetic pointer is the key information missed out by previous electronic maps.

FIG. 4 compares the Trigonometric convention (I) with the Compass convention (II). This application uses the Compass convention, in which 0° starts from the Grid North, goes clockwise with degree increasing and finishes a full circle at 360°. Trigonometric convention uses radians, where 0 radian starts from the positive x-axis, goes increasingly (positive) counter-clockwise, decreasingly (negative) clockwise, and ends at π, −π respectively on the negative x-axis. A projection from Trigonometric convention to Compass convention is applied when computing the Grid Azimuth.

FIG. 5 applies the Interactive Navigation Map to a more complicated setting, where the navigator has to cross the river (30) at bridge (40) in order to reach the destination (B). Here the trip has two legs with two magnetic azimuths: (1) and (5). The application outputs the magnetic azimuth and the distance (113.7°, 0.22 miles) for Leg 1 (L1) and (12.0°, 0.35 miles) for Leg 2 (L2) to guide the navigation.

### DETAILED DESCRIPTION OF THE DRAWINGS

The labels in all five drawings are listed below:

Waypoints:
A: Starting point.
B: Destination point.

Directions:
TN: True North.
GN: Grid North.
MN: Magnetic North.
N: Compass north pointer.
S: Compass south pointer.

Azimuths:
1: Magnetic Azimuth (θ_{M}).
2: Grid Magnetic Angle (θ_{GM}).
3: Grid Azimuth (θ_{G}).
4: Magnetic Declination.
5: The Magnetic Azimuth for the second leg.

Distance:
d: distance.

Objects:
10: Compass.
20: Hill.
30: River.
40: Bridge.

Navigation Paths:
L: Leg.
L1: The first leg.
L2: The second leg.

Conventions:
I: Trigonometric convention.
II: Compass convention.

### DETAILED DESCRIPTION OF THE INVENTION

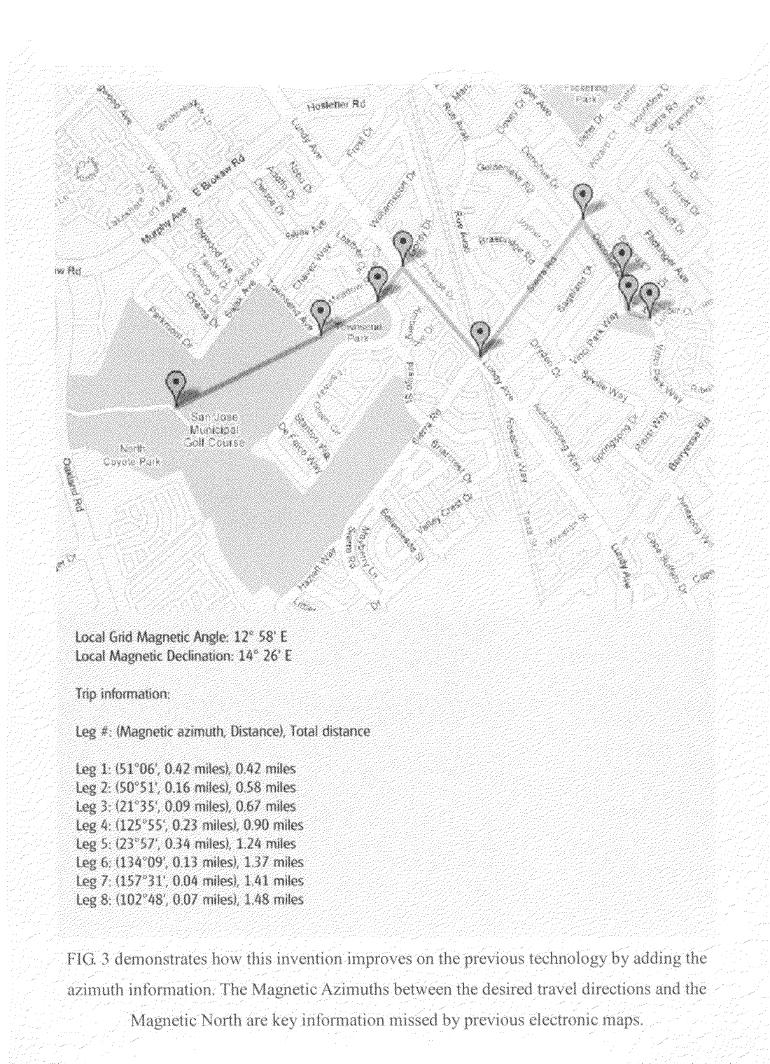

Providing the desired navigation direction relative to the Magnetic North on the electronic map is very useful for people to navigate on the land (hiking), water surface (sailing) or in the air (piloting). This invention adds the azimuth information to the electronic maps, which makes these maps useful for outdoor activities as well as for road travel. This Interactive Navigation Map provides the Magnetic Azimuth ((1) in FIG. 3) without the user doing any measurement and calculation (it is very awkward to do any measurement on the screen). In order to achieve this, the electronic map needs to know the Grid Magnetic Angle θ_{GM} for each geographic location, which can be obtained by multiple ways including but not limited to (in the order of increasing implementation effort):
1. Asking the user to interactively input the Grid Magnetic Angle θ_{GM} for the pertinent geographic location.
2. Sending an instant database query to National Geophysical Data Center (NGDC) or other supportive online resources over the Internet.
3. Embedding the Grid Magnetic Angle θ_{GM}, Magnetic Declination and Inclination information into the electronic map database beforehand.

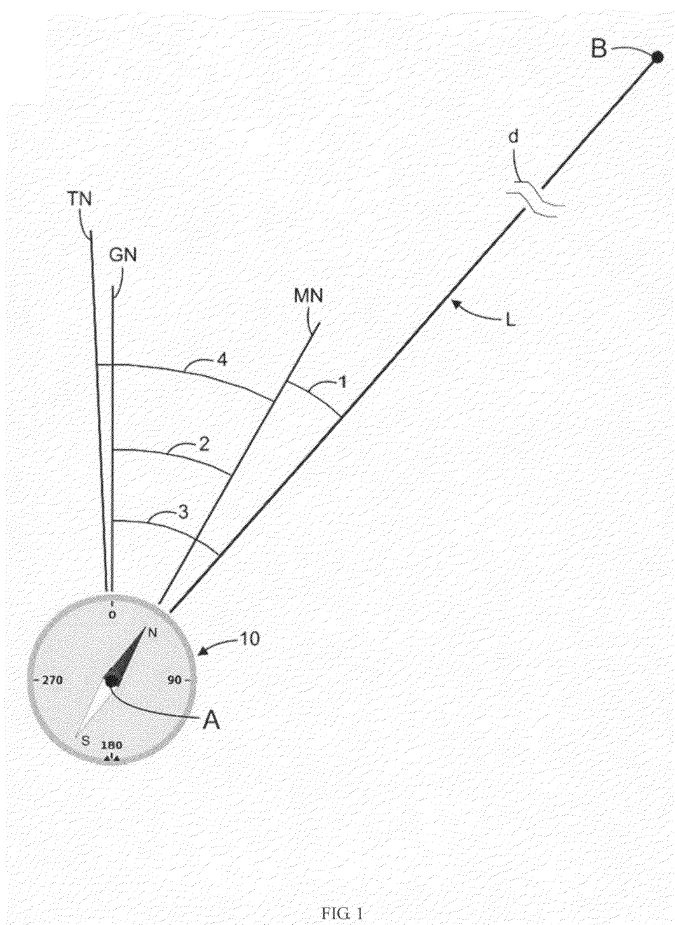

Given the (x,y) coordinates of the points (A) and (B), the application first calculates the Grid Azimuth between the Grid North (y-axis) and the vector AB using trigonometric functions, then applies the following formula to calculate the Magnetic Azimuth (see FIG. 1):

θ_{M}=θ_{G}−θ_{GM} (1)

Where
θ_{M} (1) is the Magnetic Azimuth of the desired direction relative to the Magnetic North.
θ_{G} (3) is the Grid Azimuth of the desired direction relative to the Grid North.
θ_{GM} (2) is the Grid Magnetic Angle.

Formula (1) requires the following sign regulation: Grid Magnetic Angle is positive when Magnetic North is east of the Grid North or negative when west of it. A Grid Magnetic Angle labeled as 15° E (or −15° W) means that the Magnetic North is 15° to the east (or west) of Grid North. In FIG. 1, Grid Magnetic Angle is 31° E, the Grid Azimuth is 41°, then the Magnetic Azimuth is 41°−31°=10°.

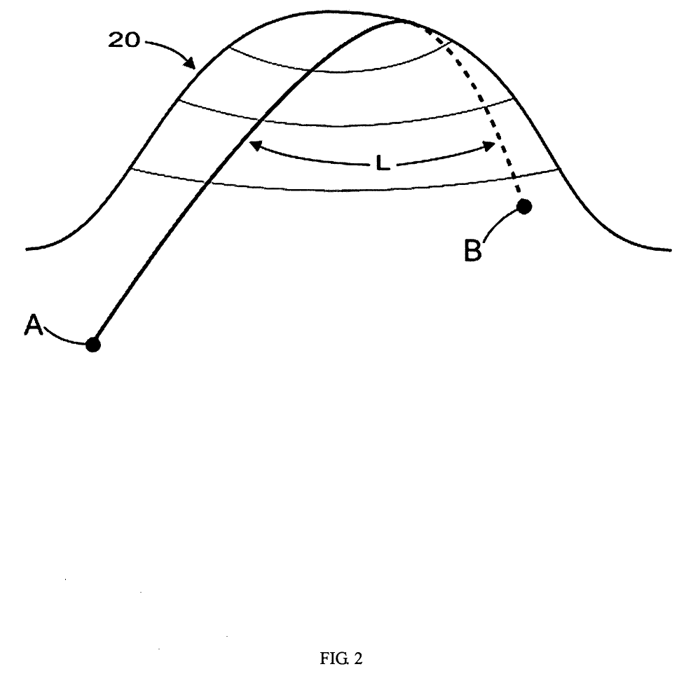

When the navigator stands at the starting point in the field, there is no indication where the Grid North or True North is. His/her compass indicates accurately where the Magnetic North is. The navigator clicks on a series of waypoints on the Interactive Navigation Map. The online map connects them into many legs, calculates the azimuth θ_{M} relative to magnetic north and the distance (d) of each leg, and output the ready-to-use information (θ_{M}, d) for the navigator equipped with a compass and an odometer. The odometer can be a simple pace counter, or the equipment built into bikes, vehicles, ships or aircrafts. By the principle of Polar coordinate system, the direction and distance information uniquely determine the target location. The existing popular online maps lack the key azimuth information (FIG. 2).

With the addition of the azimuth information, this patent keeps up the information integrity and makes the online map useful for both road travel and outdoor activities at no-road environment such as in the desert. This application also helps to teach online map users Geophysics. Therefore, the Interactive Navigation Map is useful for education, recreation, adventure and military movements. Azimuth information even helps at a street intersection to determine which road or which direction of a road to follow.

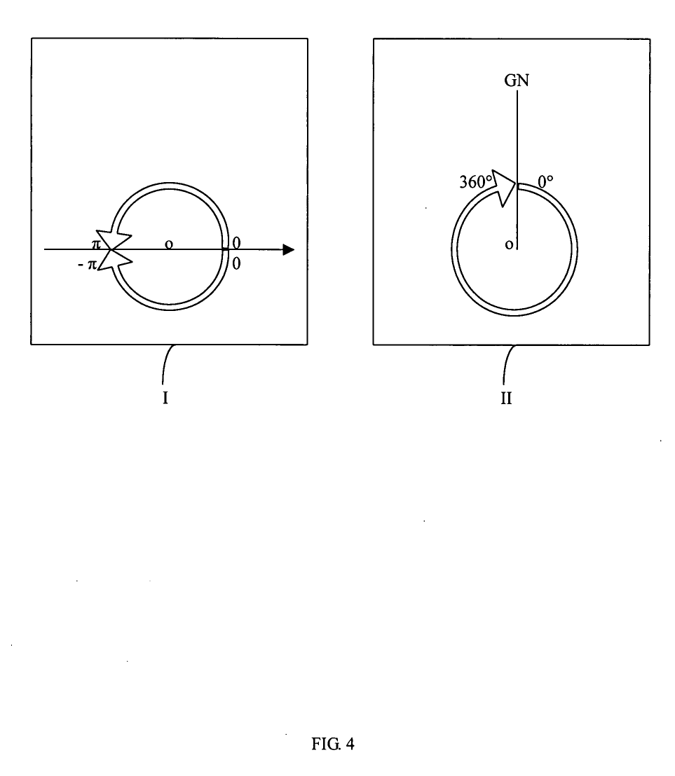

By trigonometry, the Interactive Navigation Map calculates the Grid Azimuth from input points A(x1, y1) and B(x2, y2). The following intermediate variables are defined: Δx=x2−x1, Δy=y2−y1, and r=|Δy/Δx|. Using the inverse tangent function in the first quadrant [0, π/2], with the consideration of the Trigonometric convention (I) and the Compass convention (II) (FIG. 4), and with the conversion from radians to degrees, the Grid Azimuth is:

θ_{G}=90°−a tan(r)*180°/π, for the first quadrant(Δx>0, Δy>0)

θ_{G}=270°+a tan(r)*180°/π, for the second quadrant(Δx<0, Δy>0)

θ_{G}=270°+a tan(r)*180°/π, for the third quadrant (Δx<0, Δy<0)

θ_{G}=90°+a tan(r)*180°/π, for the fourth quadrant (Δx>0, Δy<0)

θ_{G}=0°, for positive y axis (Δx=0, Δy>0)

θ_{G}=90°, for positive x axis (Δx>0, Δy=0)

θ_{G}=180°, for negative y axis (Δx=0, Δy<0)

θ_{G}=270°, for negative x axis (Δx<0, Δy=0)

θ_{G}=uncertain, when (Δx=0, Δy=0). That means points (A) and (B) collapse into one. The system simply outputs “(On target, 0 miles)” and moves on to the next leg. (2)

θ_{GM} is obtained by any of the methods listed in [0025]. Finally the system applies equation (1) to obtain the Magnetic Azimuth θ_{M}.

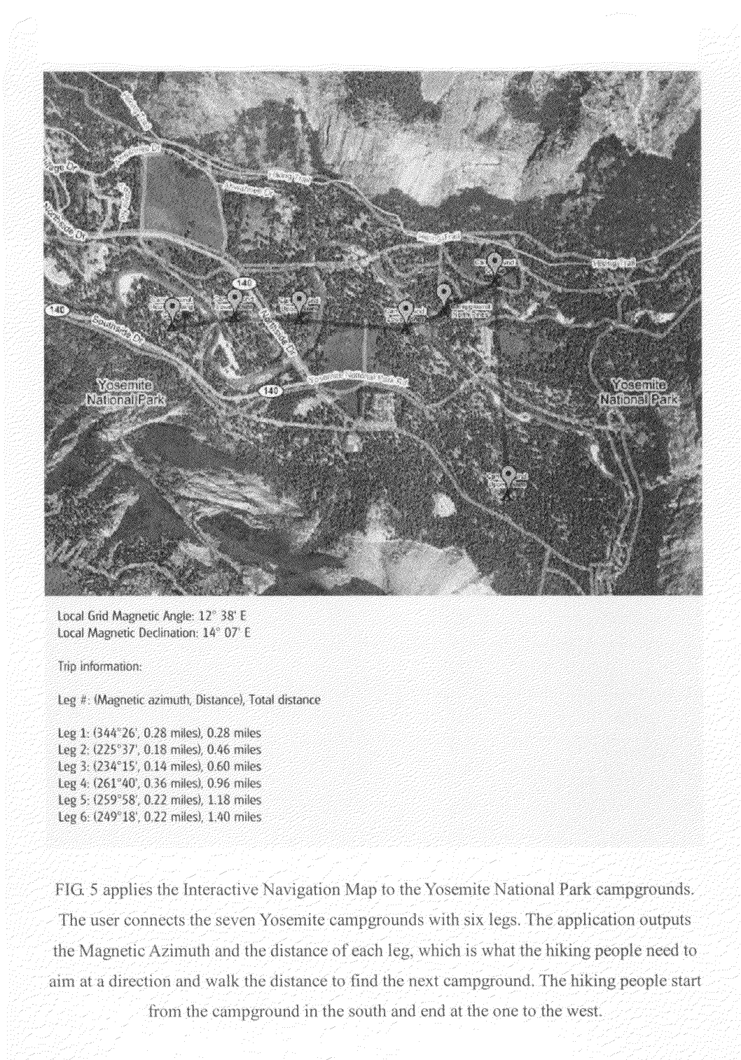

A more complicated application with two legs is shown in FIG. 5. It provides necessary and sufficient information (θ_{M}, d) for hiking team to move from starting point (A) to the bridge (40) and to final destination (B). If James Kim were educated by the online Interactive Navigation Map and had a compass built into his watch, he probably would not have got lost and died in southern Oregon woods.

1. The Interactive Navigation Map maintains information integrity by presenting both azimuths and distance concepts to the mobile or stationary users.

2. Among many types of azimuths, the Interactive Navigation Map provides the most ready-to-use azimuth information for navigation: the magnetic azimuth θ_{M}, which is the horizontal angle between Magnetic North and the travel direction.

3. The Interactive Navigation Map obtains the Grid Magnetic Angle θ_{GM} for each geographic location via multiple channels, including but not limited to: (a) Storing the Grid Magnetic Angle θ_{GM}, along with related Magnetic Declination and Inclination information of each geographic location in the map's database. (b) Sending instant database queries to other online resources over the Internet to get the Grid Magnetic Angle θ_{GM}. (c) Asking the user to input or confirm the Grid Magnetic Angle θ_{GM}.

4. The azimuths mentioned in claim 1 include both grid and magnetic azimuths.

5. After the user input of a series of waypoints on the Interactive Navigation Map, the method of claim 1 includes the step of calculating the Grid Azimuth θ_{G} and the length of each leg connecting two consecutive waypoints.

6. The method of claim 2 includes the step of converting the Grid Azimuth θ_{G} into the most ready-to-use Magnetic Azimuth θ_{M} by offsetting the Grid Magnetic Angle θ_{GM}.

7. The claim 3 (c) includes the statistical analysis of Grid Magnetic Angle θ_{GM} from multiple user inputs for machine learning purpose.

8. The geographical location in claim 3 is a closed region defined on a map by longitude (X), latitude (Y), and altitude (Z).

9. The system of claim 1 is an HTTP server connected to the Internet, allowing public mobile and stationary users to interact with the system via standard Web browsers through reserved Transmission Control Protocol (TCP/IP) port number 80.

10. The system of claim 1 also supports TCP/IP connection with customized port numbers, allowing specific customers to query.

11. The system of claim 1 supports multiple means of user input including: (a) selecting the waypoints on the interactive map, or (b) typing in the longitude (X), latitude (Y), and altitude (Z) of each waypoint, or (c) accepting incoming query with (X, Y, Z) information through TCP/IP connection.

12. The system of claim 1 comprises multiple means to send the results to the users including: (a) displaying (θ_{M}, d) pairs on the graphical user interface, or (b) emailing the results by a convenient hyperlink, or (c) replying the incoming query through direct TCP/IP.

13. The system of claim 1 comprises means to save the waypoints with four columns representing waypoint ID, longitude (X), latitude (Y), and altitude (Z) into a file in Geography Markup Language (GML) format, and the file can be reloaded for easy viewing.

14. The system of claim 1, further comprises means for recording public map queries, in support of National Security Surveillance.

15. The claim 14 includes reporting suspicious excessive online map viewing and trip planning on sensitive targets such as airport, national border, military reserved bases, etc to the authority.

16. The premium version of the system in claim 1 comprises a global positioning system (GPS) to monitor the actual route of travel for training purpose.

17. Upon completion of the trip, the premium system in claim 16 overlays the actual route of travel from the GPS on top of the planned route for comparison.

18. (canceled)

19. (canceled)

20. (canceled)

21. (canceled)

22. (canceled)

23. (canceled)

24. (canceled)
